(19) United States
(12) Patent Application Publication
(10) Pub. No.: US 2006/0113828 A1
(43) Pub. Date: Jun. 1, 2006

(54) Flip and slide seat assembly

(76) Inventors: Christopher J. Ryan, Fraser, MI (US); Srinivas Pejathaya, St. Clair Shores, MI (US)

Correspondence Address: HARNESS, DICKEY & PIERCE, P.L.C., P.O. BOX 828, BLOOMFIELD HILLS, MI, 48303, US

(21) Appl. No.: 11/288,037

(22) Filed: Nov. 28, 2005

Related U.S. Application Data
(63) Continuation-in-part of application No. 11/001,653, filed on Dec. 1, 2004.

(51) Int. Cl. B60N 2/02

(52) U.S. Cl. 297/336

(57) ABSTRACT

A vehicle seat recliner assembly is provided. The assembly generally includes a base, a kneel latch, a first drive member, a support bracket and a carrier link. The kneel latch is attached to the base. The first drive member is supported on the kneel latch. The support bracket is located in a common plane with the base having a slot located therein. A recliner arm is pivotally coupled to the support bracket. The carrier link has a first end pivotally attached to the first drive member and a second end both pivotally and slidably attached to the slot in said support bracket. The carrier link is adapted to selectively displace the first drive member to either an ingress/egress position or a kneel position.

### CROSS-REFERENCE TO RELATED APPLICATIONS

This application is a continuation-in-part of U.S. patent application Ser. No. 11/001,653 filed on Dec. 1, 2004. The disclosure of the above application is incorporated herein by reference.

### FIELD

The present invention relates to a vehicle seat recliner assembly and, more particularly, to a flip and slide seat frame assembly providing for ingress/egress to the area behind the vehicle seat for cargo, as well as third row access.

### BACKGROUND

Minivan and sport utility markets are extremely competitive. A growing focus of the competition is the overall utility and comfort of these vehicles. One important utility feature that is gaining much attention includes flexible vehicle interiors and, more particularly, flexible second row seating assemblies. Flexibility, in this sense, refers to the ability to modify the configuration of a particular seating assembly. For example, when a passenger wants to access a third row, this feature provides more ingress/egress room. Additionally the passenger might desire to fold down a front or second row seat to provide for a workspace during travel. As such, the passenger could use the rear of the seat back as a table top. This feature also allows for more cargo space.

### SUMMARY

A vehicle seat recliner assembly may generally include a base, a kneel latch, a first drive member, a support bracket and a carrier link. The kneel latch may be attached to the base. The first drive member may be supported on the kneel latch. The support bracket may be located in a common plane with the base and have a slot located therein. A recliner arm may be pivotally coupled to the support bracket. The carrier link may have a first end pivotally attached to the first drive member and a second end both pivotally and slidably attached to the slot in said support bracket. The carrier link may selectively displace the first drive member to either an ingress/egress position or a kneel position.

Further areas of applicability of the present disclosure will become apparent from the detailed description provided hereinafter. It should be understood that the description and examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a first vehicle seat recliner assembly in accordance with the present invention in an operating position;

FIG. 2 is an exterior side view of a first lateral subassembly of the vehicle seat recliner assembly of FIG. 1 in an operating position;

FIG. 3 is an exploded view of the first lateral subassembly of FIG. 2;

FIG. 4 is an exterior side view of a support assembly of the first lateral subassembly of FIG. 1;

FIG. 5 is an interior side view of the support assembly of FIG. 4;

FIG. 6 is an exterior side view of the first lateral subassembly of FIG. 1 in an ingress/egress position;

FIG. 7 is a side view of a vehicle seat assembly in accordance with the present invention in an operating position;

FIG. 8 is a side view of the vehicle seat assembly of FIG. 7 in an ingress/egress position;

FIG. 9 is a perspective view of a second vehicle seat recliner assembly in accordance with the present invention in an operating position;

FIG. 10 is an exterior side view of a first lateral subassembly of the vehicle seat recliner assembly of FIG. 9 in an operating position;

FIG. 11 is an exploded view of the first lateral subassembly of FIG. 10;

FIG. 12 is an exterior side view of a support assembly of the first lateral subassembly of FIG. 9;

FIG. 13 is an interior side view of the support assembly of FIG. 12;

FIG. 14 is an exterior side view of the kneel latch of FIG. 9;

FIG. 15 is an exterior side view of the first lateral subassembly of FIG. 9 in an ingress/egress position;

FIG. 16 is an exterior side view of the first lateral subassembly and kneel latch of FIG. 9 in a kneel position;

FIG. 17 is a side view of a vehicle seat assembly in accordance with the present invention in an operating position;

FIG. 18 is a side view of the vehicle seat assembly of FIG. 17 in an ingress/egress position; and

FIG. 19 is a side view of the vehicle seat assembly of FIG. 17 in a kneel position.

### DETAILED DESCRIPTION

The following description is merely exemplary in nature and is in no way intended to limit the scope of the present disclosure, its application, or its uses.

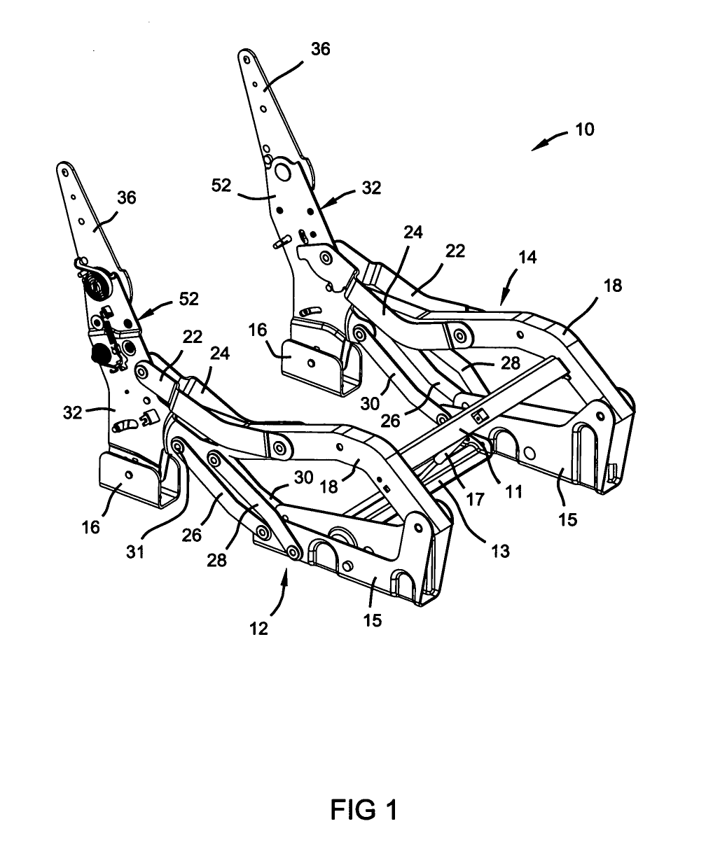

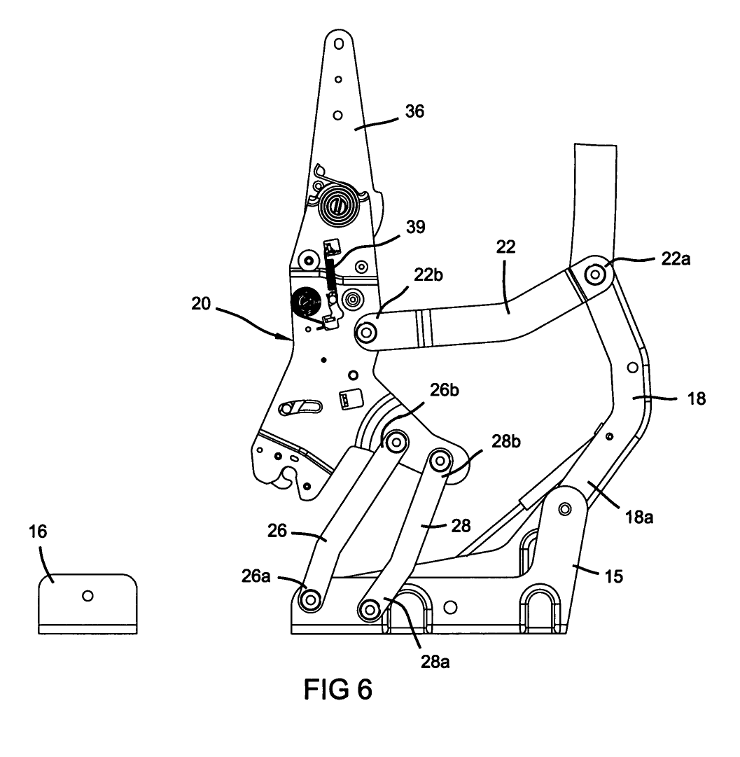

With reference to FIG. 1, a vehicle seat recliner assembly 10 generally includes first and second lateral subassemblies 12, 14 connected by upper and lower cross braces 11, 13. A strut 17 is disposed between the upper and lower cross braces 11, 13 to bias the assembly 10 out of the position illustrated in FIG. 1, which is described herein as the operating position, toward the position illustrated in FIG. 6, which is described herein as the ingress/egress position. It should be appreciated that the lateral assemblies 12, 14 are mirror images of each other and that they include similar elements.

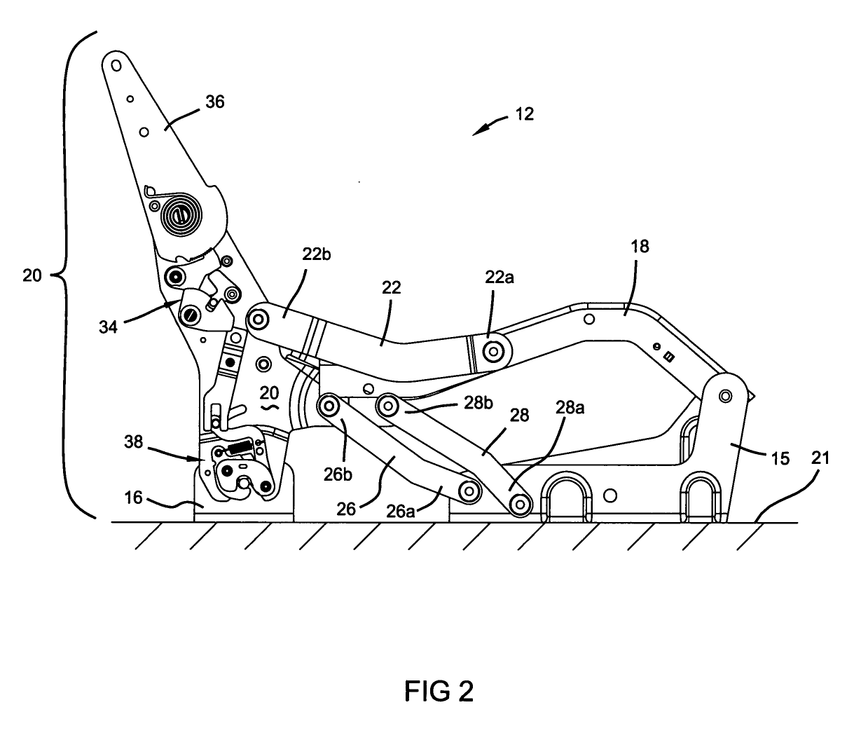

Referring to FIGS. 2-4, the lateral subassemblies 12, 14 are described with specific reference to the first lateral subassembly 12. The first lateral subassembly 12 generally includes a base 15, a striker plate 16, a drive member 18, a support assembly 20, and a linkage assembly 25. The base 15 is a U-shaped metal bracket that is adapted to be attached to a vehicle floor 21. The striker plate 16 is a U-shaped metal bracket that is adapted to be attached to a vehicle floor. The striker plate 16 is located directly behind of the base 15 and includes a striker pin 19. The drive member 18 is a metal channel having a generally upside down U-shaped cross section including a first end 18a pivotally attached to the base 15.

The support assembly 20 generally includes an exterior support bracket 32, an interior support bracket 52, a recliner mechanism 34, and a striker pin latch mechanism 38. The recliner mechanism 34 is rotatably supported between the first and second support brackets 32, 52.

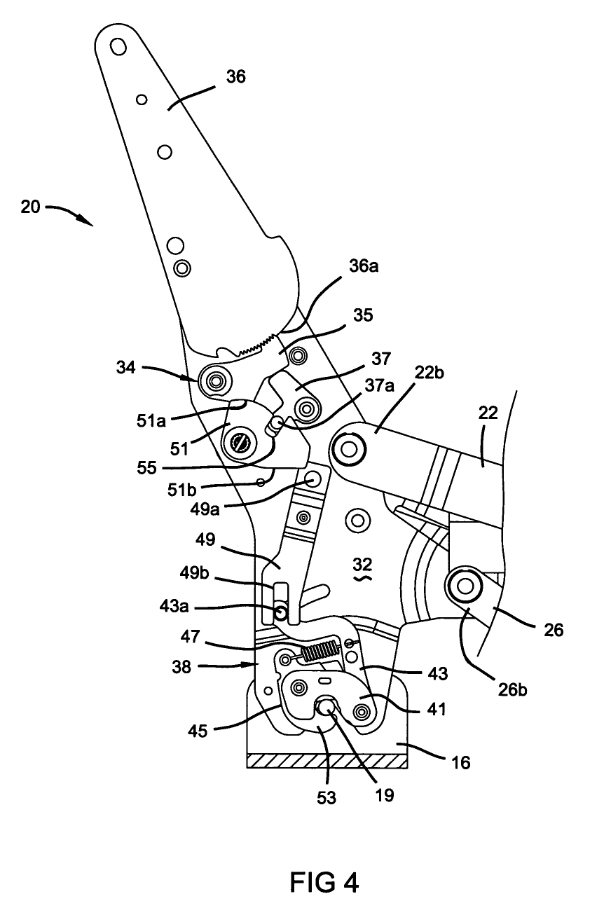

With specific reference to FIG. 4, the recliner mechanism 34 includes a recliner arm 36, a pawl 35, a release cam 37, a coil spring 39, and an interlocking cam 51. The recliner arm 36 is supported for pivotal displacement on the support bracket 32 and includes an arcuate edge 36a having a plurality of teeth 40. The pawl 35 is also supported for pivotal displacement on the support bracket 32 and includes a plurality of teeth 42 adapted to lockingly engage the plurality of teeth 40 on the recliner arm 36. The release cam 37 is supported for pivotal displacement on the support bracket 32 and engages the pawl 35, thereby locking the teeth 42 on the pawl 35 into engagement with the teeth 40 on the recliner arm 36. A coil spring 39 is disposed between the recliner arm 36 and the release cam 37 to bias the release cam 37 into engagement with the pawl 35 to lock the recliner mechanism 34. The interlocking cam 51 is disposed between the release cam 37 and the pawl 35, and is adapted to prevent the recliner mechanism 34 from disengaging under certain conditions, as will be described in more detail in correlation with the striker pin latch mechanism 38.

With continued reference to FIG. 4, the striker pin latch mechanism 38 is attached to the support bracket 32 and adapted to lock the support assembly 20 to the striker pin 19 on the striker plate 16. The striker pin latch mechanism 38 includes a housing plate 41, a release lever 43, a lock claw 45, a biasing member 47, and an interlocking lever 49. The housing plate 41 is mounted to the support bracket 32. The release lever 43 is supported on the support bracket 32 for pivotal displacement between a latched position (shown in FIG. 4) and an unlatched position (not shown). The lock claw 45 is supported for rotational displacement on the support bracket 32 and includes a claw portion 53 adapted to engage the striker pin 19 when the release lever 43 is in the latched position. The biasing member 47 is disposed between the lock claw 45 and the release lever 43 and is adapted to bias the lock claw 45 into locking engagement with the striker pin 19. The interlocking lever 49 is disposed between the release lever 43 and the interlocking cam 51 of the recliner mechanism 34 and is supported for rotational displacement on the support bracket 32.

The interlocking lever 49 includes a first end having a boss 49a for selectively engaging the interlocking cam 51 and a second end having a slot 49b engaging a boss 43a formed on the release lever 43. The interlocking cam 51 is disposed between the release cam 37 and pawl of the recliner mechanism 34. The interlocking cam 51 includes an arcuate edge 51a, a slot 55, and a locking surface 51b. The arcuate edge 51a engages the pawl 35 and the slot 55 engages a boss 37a formed on the release cam 37. The locking surface 51b is adapted to be engaged by the boss 49a on the interlocking lever 49 when the striker pin latch mechanism 38 is disengaged. The above-described configuration provides a feature that prevents the recliner mechanism 34 from being disengaged when the striker pin latch mechanism 38 is disengaged from the striker plate 16, thereby preventing multiple simultaneous operations and confusion to the consumer.

To disengage the striker pin latch mechanism 38 from the striker pin 19, the release lever 43 is pivoted in a clockwise direction. This rotates the lock claw 45 out of locking engagement with the striker pin 19. The interlocking lever 49 rotates counter-clockwise such that the boss 49 formed thereon engages the lock surface 51b on the interlocking cam 51. Thus, the arcuate edge 51a engages the pawl 35 and prevents the pawl 35 from disengaging the recliner arm 36. The interlocking lever 49 and interlocking cam 51, in effect, act as a column between the pawl 35 and boss 43a formed on the release lever 43.

With reference to FIGS. 2, 3, and 5, the linkage assembly 25 includes first and second carrier links 22, 24, first and second external vault links 26, 28, and an internal vault link 30. The first and second carrier links 22, 24 each include first ends 22a, 24a pivotally attached to the drive member 18 and second ends 22b, 24b pivotally attached to the support bracket 32. In an exemplary embodiment, the carrier links 22, 24 resemble bell cranks.

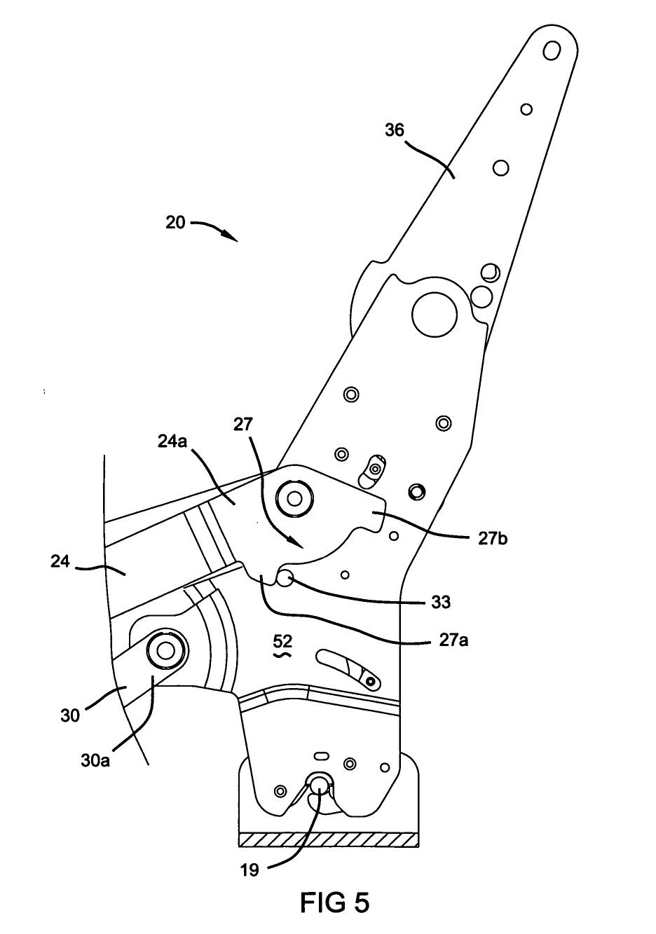

Referring specifically to FIG. 5, the second carrier link 24 further includes a hip flange 27 formed on its second end 24b. The hip flange 27 includes a first shoulder 27a and a second shoulder 27b. The first shoulder 27a engages a boss 33 formed on the interior support bracket 52 when the assembly 10 is in the operating position (shown in FIG. 5). The second shoulder 27b is adapted to engage the boss 33 when the second carrier link 24 pivots about the support assembly 20 to the ingress/egress position (shown in FIG. 6). In each position, the respective shoulders 27a or 27b act as a stop by engaging the boss 33, thereby preventing over-rotation of the carrier links 22, 24 and the drive member 18.

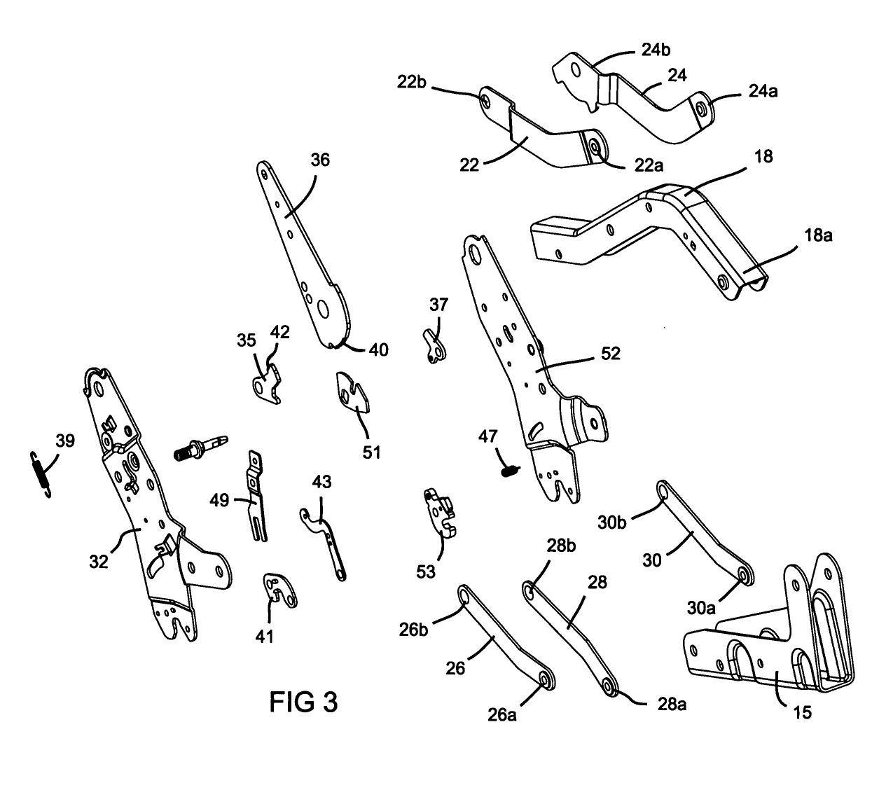

Referring back to FIGS. 2 and 3, the vault links 26, 28, 30 each have first ends 26a, 28a, 30a pivotally attached to the base 15 and second ends 26b, 28b, 30b pivotally attached to the support bracket 32. Furthermore, the vault links 26, 28, 30 each have slightly V-shaped profiles. Lastly, each of the aforesaid pivotal attachments is achieved through the use of a fastener 31. In an exemplary embodiment, the fastener 31 includes a rivet; however, other types of fasteners are intended to be within the scope of the present invention.

The vehicle seat recliner assembly 10 is manipulable between an operating position, shown in FIG. 1, and an ingress/egress position, shown in FIG. 6. To do so, the striker pin latch mechanism 38 is decoupled from the striker pin 19 in the manner described above. This enables the drive member 18 to pivot in a clockwise direction about its first end 18a from a seating position, shown in FIG. 1, to an ingress/egress position, shown in FIG. 6. This causes the carrier links 22, 24 to rotate in a counterclockwise direction about the support assembly 20, thereby disengaging the first shoulder 27a of the hip flange 27 from the boss 33 disposed on the interior support bracket 52. Subsequent to the drive member 18 pivoting a predetermined amount, the second shoulder 27b on the hip flange 27 engages the boss 33 and the carrier links 22, 24 cease rotation. This causes the carrier links 22, 24 to displace forward, pulling the support assembly 20 along. As the support assembly 20 displaces forward, the vault links 26, 28, 30 initially displace the support assembly 20 upward and then downward. Therefore, the combination of carrier 22, 24 and vault 26, 28, 30 links forces the support assembly 20 to move along an arch-shaped travel path from the operating position, shown in FIG. 2, to the ingress/egress position, shown in FIG. 6.

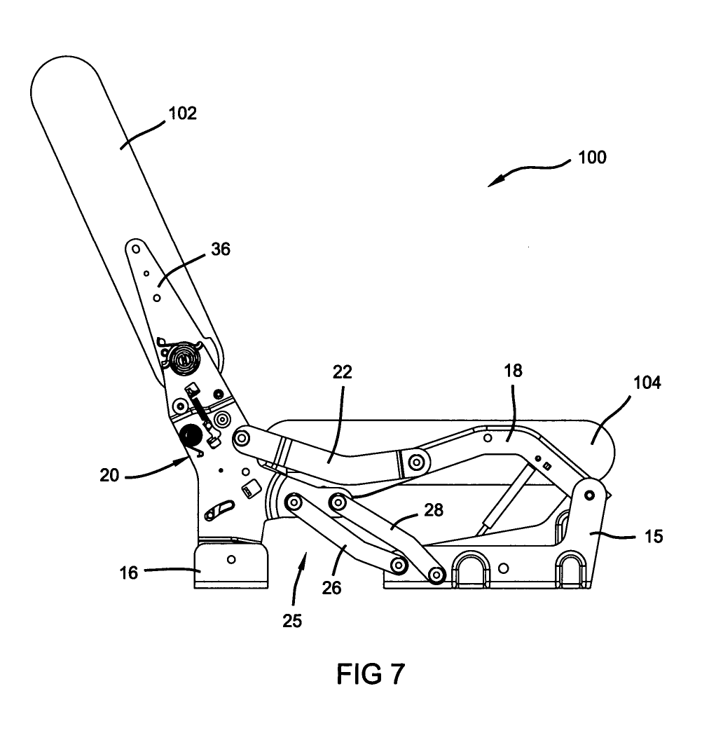

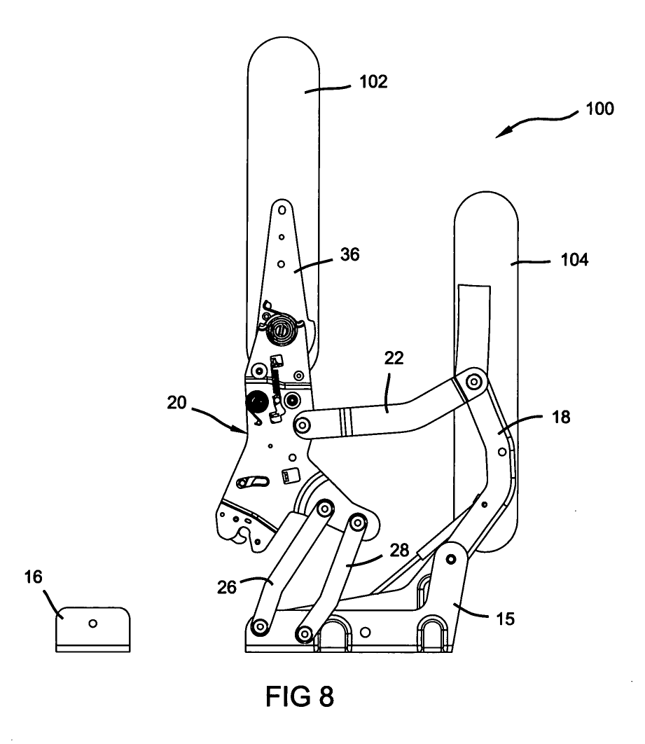

With reference now to FIGS. 7 and 8, a vehicle seat assembly 100 in accordance with the present invention is described. The vehicle seat assembly 100 generally includes a seat back 102, a seat bottom 104, and a vehicle seat recliner assembly 10. The vehicle seat recliner assembly 10 is identical to that described above and includes first and second lateral subassemblies 12, 14 connected by upper and lower cross braces 11, 13. Each of the lateral assemblies 12, 14 include a base 15, a striker plate 16, a drive member 18, a support assembly 20, and a linkage assembly 25. As described above, the support assembly 20 include first and second support brackets 32, 52, a recliner mechanism 34, and a striker pin latch mechanism 38. The seat back 102 is attached between the lateral subassemblies 12, 14 to the recliner arms 36 of the recliner mechanisms 34. The seat bottom 104 is attached between the lateral subassemblies 12, 14 to the drive members 18.

Operation of the vehicle seat assembly 100 mirrors the operation of the vehicle seat recliner assembly 10 described above. The striker pin latch mechanism 38 is decoupled from the striker plate 16. The seat bottom 104 is pivoted in a clockwise direction relative to the base 15. This initially causes the carrier links 22, 24 to rotate in a counterclockwise direction about the support assembly 20, thereby disengaging the first shoulder 27a of the hip flange 27 from the boss 33 formed on the interior support bracket 32. Subsequent to the seat bottom 104 pivoting a predetermined amount, the second shoulder 27b on the hip flange 27 engages the boss 33 and the carrier links 22, 24 cease rotation. This causes the carrier links 22, 24 to displace forward, pulling the seat back 102 along. As the seat back 102 displaces forward, the vault links 26, 28, 30 displace the seat back 102 initially upward and then downward. Therefore, the combination carrier 22, 24 and vault 26, 28, 30 links forces the seat back 102 to move along an arch-shaped travel path from the operating position, shown in FIG. 7, to the ingress/egress position, shown in FIG. 8.

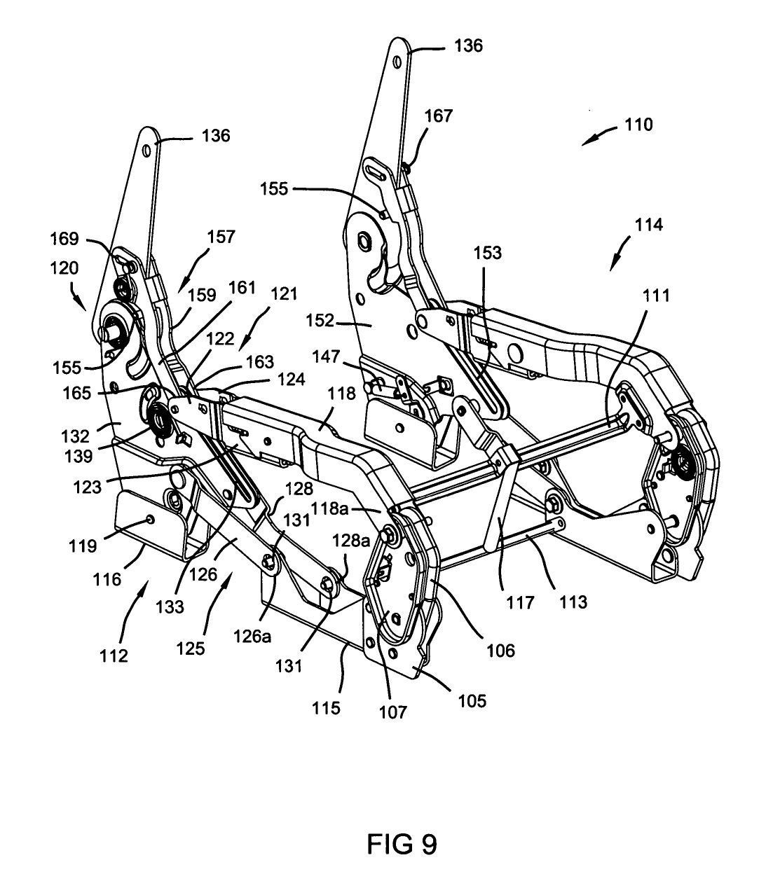

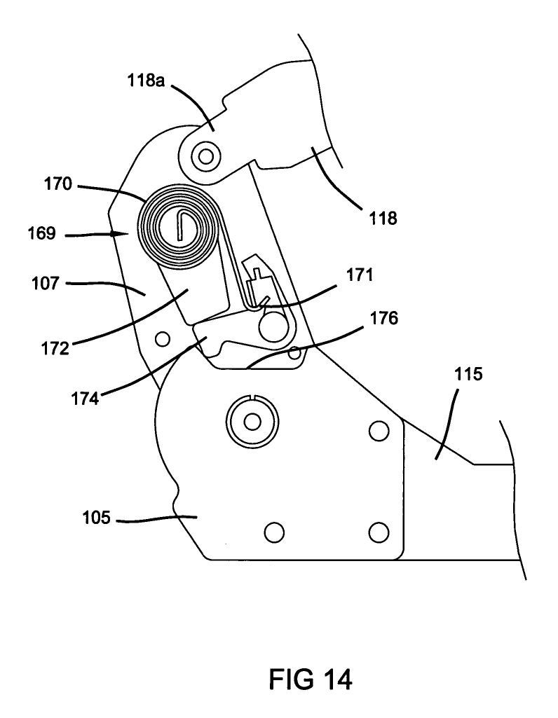

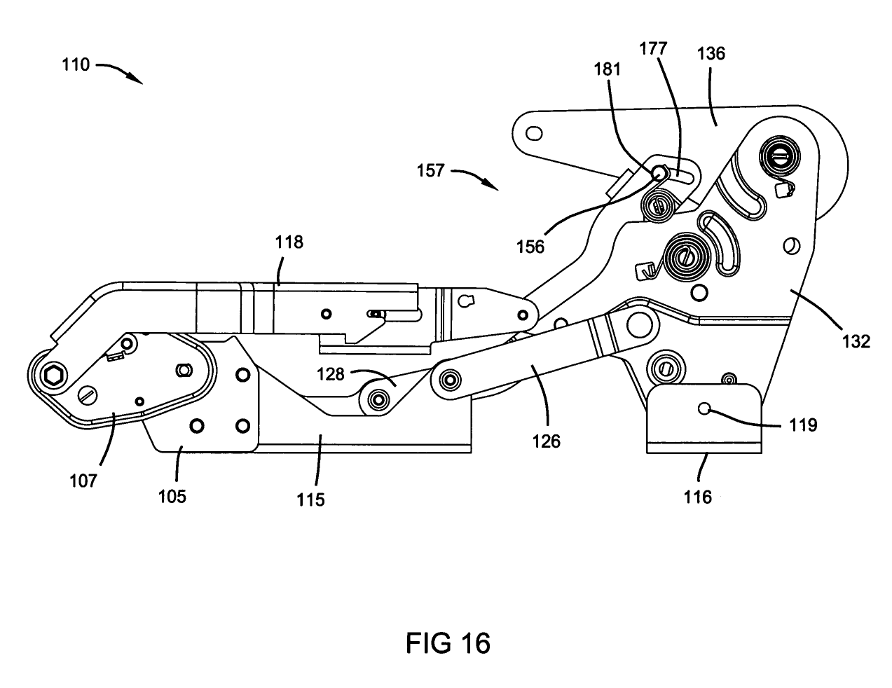

With reference to FIG. 9, an additional vehicle seat recliner assembly 110 generally includes first and second lateral subassemblies 112, 114 connected by upper and lower cross braces 111, 113. A strut 117 is disposed between the upper and lower cross braces 111, 113 to bias the assembly 110 out of an operating position illustrated in FIG. 9, toward an ingress/egress position illustrated in FIG. 14. The strut 117 additionally biases the assembly 110 out of the operating position toward a kneel position illustrated in FIG. 16. It should be appreciated that the lateral assemblies 112, 114 are mirror images of each other and that they include similar elements.

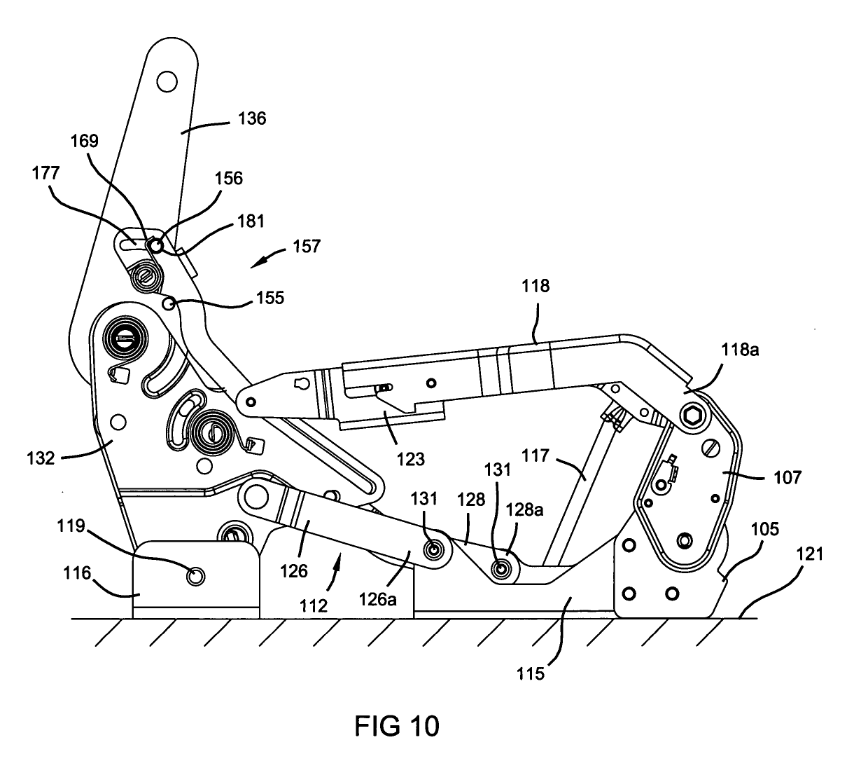

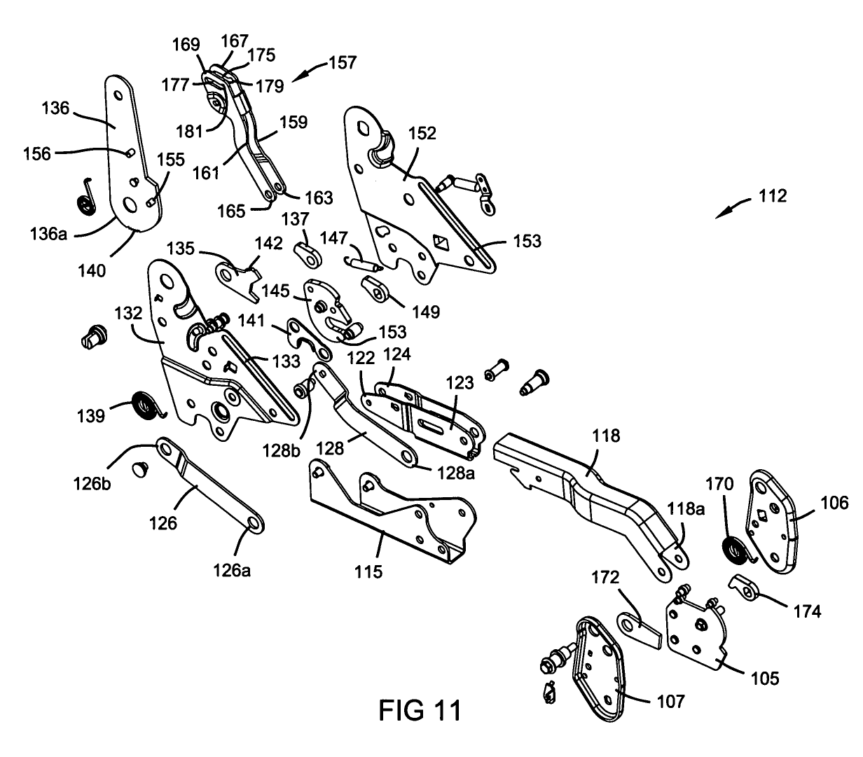

With additional reference to FIGS. 10-11, the lateral subassemblies 112, 114 are described with specific reference to the first lateral subassembly 112. The first lateral subassembly 112 generally includes a base 115, a striker plate 116, a base flange 105, inner and outer kneel latches 106, 107, a first drive member 118, a support assembly 120, and a linkage assembly 125. The base 115 is a U-shaped metal bracket and is attached to a vehicle floor 127. The base includes flange 105 fixed to an outer surface thereof. The kneel latch 106 is rotatably coupled to the base flange 105 and the base 115 may be selectively rotated. The striker plate 116 is a U-shaped metal bracket and is attached to the vehicle floor 127. The striker plate 116 is located directly behind of the base 115 and includes a striker pin 119. The first drive member 118 is a metal channel having a generally upside down U-shaped cross section including a first end 118a pivotally attached to the kneel latches 106, 107.

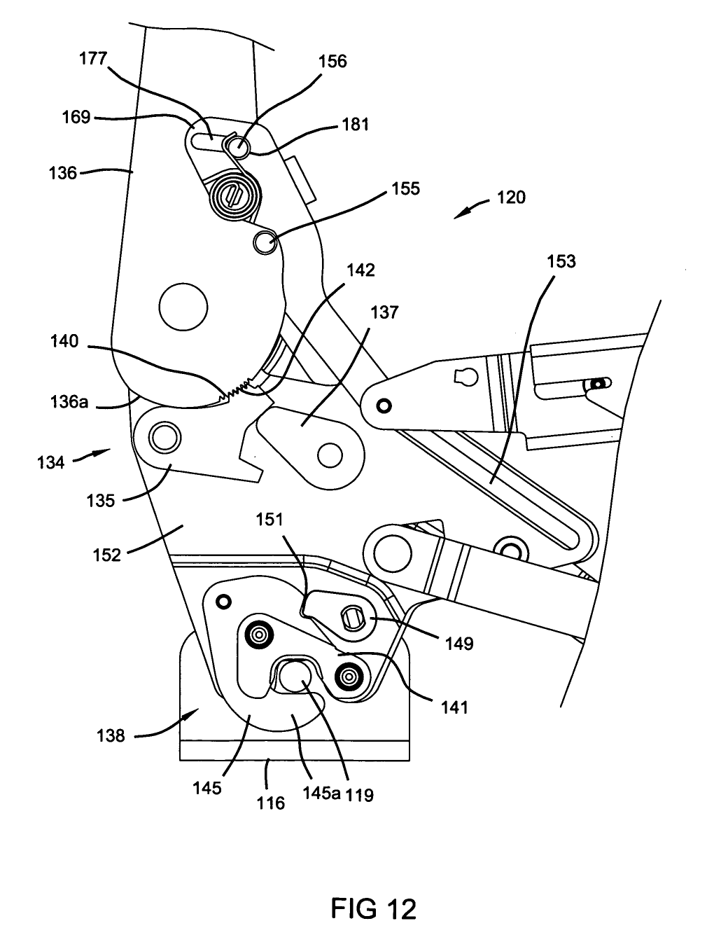

With additional reference to FIG. 12, the support assembly 120 generally includes an exterior support bracket 132, an interior support bracket 152, a recliner mechanism 134, and a striker pin latch mechanism 138. The exterior and interior support brackets 132, 152 are similar to those discussed above with respect to vehicle seat recliner assembly 10. However, the support brackets 132, 152 of the present example include angled slots 133, 153 that provide a kneel position in addition to the previously discussed ingress/egress position. The recliner mechanism 134 is rotatably supported between the first and second support brackets 132, 152.

With specific reference to FIG. 12, the recliner mechanism 134 includes a recliner arm 136, a pawl 135, a release cam 137 and a torsional spring 139 (shown in FIGS. 9 and 11). The recliner arm 136 is supported for pivotal displacement by support bracket 152 and includes an arcuate edge 136a having a plurality of teeth 140, kneel stops 155 and drive posts 156. The pawl 135 is similarly supported for pivotal displacement by support bracket 152 and includes a plurality of teeth 142 that lockingly engage the plurality of teeth 140 on the recliner arm 136. The release cam 137 is supported for pivotal displacement by the support bracket 132 and selectively engages the pawl 135 to position the teeth 142 into engagement with teeth 140 of the recliner arm 136. The torsional spring 139 is disposed proximate the release cam 137 and biases the release cam 137 into engagement with the pawl 135 to lock the recliner mechanism 134.

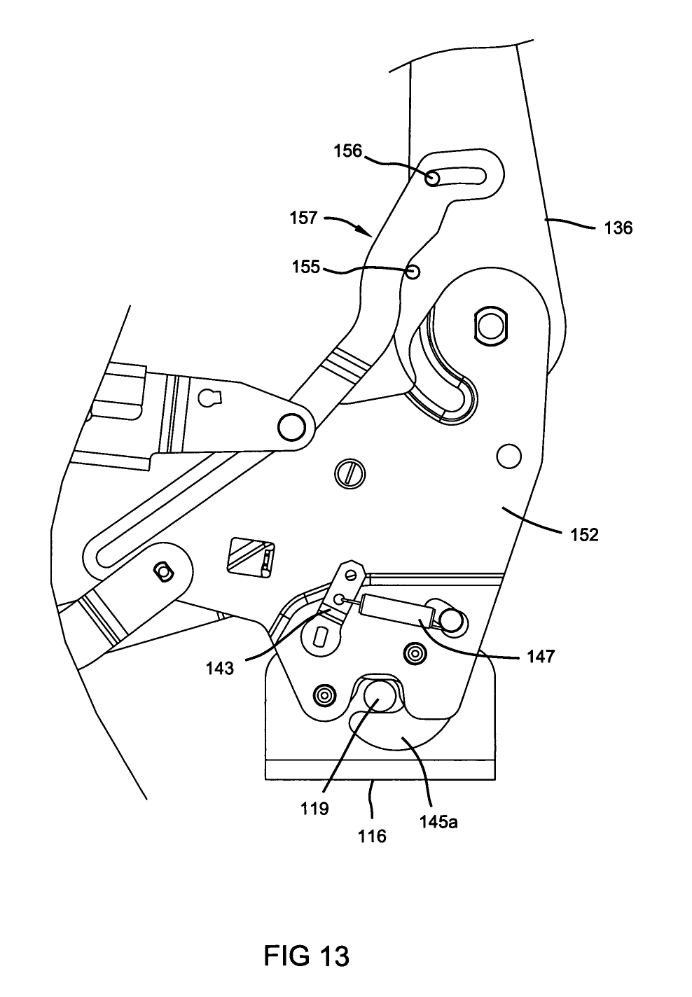

With continued reference to FIG. 12 and additional reference to FIG. 13, the striker pin latch mechanism 138 is attached to the support bracket 152 and selectively locks the support assembly 120 to the striker pin 119. The striker pin latch mechanism 138 includes a housing plate 141, a release lever 143, a lock claw 145, a biasing member 147, and a release cam 149. The housing plate 141 is mounted to the support bracket 152. The release lever 143 and release cam 149 are supported by the support bracket 152 for pivotal displacement between a latched position (shown in FIG. 12) and an unlatched position (not shown). The lock claw 145 is supported for rotational displacement by the support bracket 152 and includes a claw portion 145a that engages the striker pin 119 when the release lever 143 is in the latched position. The biasing member 147 is disposed between the lock claw 145 and the release lever 143 and biases the lock claw 145 into locking engagement with the striker pin 119. The release cam 149 is disposed between the release lever 143 and the support bracket 152 of the recliner mechanism 134 and is supported for rotational displacement by the support bracket 152.

The release cam 149 engages a notch 151 in the lock claw 145 when in a locked position (shown in FIG. 12). The release lever 143 and release cam 149 are pivoted in a clockwise direction, relative to the view shown in FIG. 12, to disengage the striker pin latch mechanism 138 from the striker pin 119. Rotation of the release lever 143 and release cam 149 disengages the release cam 149 from the notch 151 in the lock claw 145 and rotates the lock claw 145 out of locking engagement with the striker pin 119.

With reference to FIGS. 9, 10, and 11, the linkage assembly 125 includes a carrier link 121 having first and second arms 122, 124 extending therefrom, a second drive member 157, and first and second external vault links 126, 128. The carrier link 121 includes a body 123 having a generally U-shaped cross-section. The body 123 is pivotally attached to the first drive member 118 and the arms 122, 124 are pivotally and slidably attached to the slots 133, 153 in the support brackets 132, 152.

The second drive member 157 generally includes two arms 159, 161 having first and second ends 163, 165, 167, 169. The first ends 163, 165 are rotatably and slidably engaged with the slots 133, 153, while the second ends 167, 169 are rotatably engaged with the recliner arm drive posts 156. Slots 175, 177 in second ends 167, 169 generally engage drive posts 156.

The vault links 126, 128 each have first ends 126a, 128a pivotally attached to the base 115 and second ends 126b, 128b pivotally attached to the support bracket 132. Each of the aforesaid pivotal attachments is achieved through the use of a fastener 131. In an exemplary embodiment, the fastener includes a rivet; however, other types of fasteners are intended to be within the scope of the present disclosure.

With reference to FIG. 14, the kneel latch 107 is shown in greater detail. The kneel latch 107 includes an actuation assembly 173 mounted thereon for selectively releasing the kneel latch 107 from engagement with a lock feature 176 in the base flange 105.

The actuation assembly 173 includes a torsional spring 170, a release cam 172 and a pawl 174. The torsional spring 170 and release cam 172 are generally fixed to one another for rotation relative to the kneel latch 107. The torsional spring 170 includes an arm 171 fixedly attached to the kneel latch 107, thereby biasing the release cam 172 into engagement with the pawl 174. The pawl 174 is rotatably coupled to the kneel latch 107 and engages the lock feature 176 of the base flange 105 when engaged by the release cam 172 and disengages the lock feature 176 when disengaged from the release cam 172.

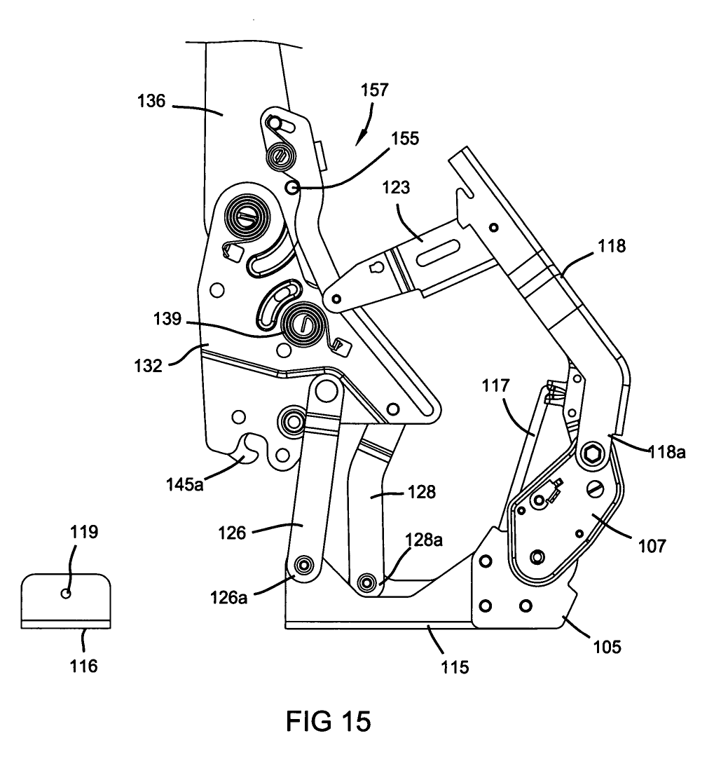

With particular reference to FIGS. 9, 15 and 16, operation of the vehicle seat recliner assembly 110 will be described in detail. In addition, the vehicle seat recliner assembly 110 is manipulable between an operating position, shown in FIG. 9, and an ingress/egress position, shown in FIG. 15. The vehicle seat recliner assembly 110 is also manipulable between an operating position, shown in FIG. 9, and a kneel position, shown in FIG. 16 through an actuation of recliner mechanism 134. Movement between the operating position and the ingress and egress position is accomplished in a manner similar to that described above with respect to vehicle seat recliner assembly 10. The second drive member 157 remains generally stationary during movement of the vehicle seat recliner assembly 110 from the operating position to the ingress/egress position.

With reference to FIG. 16, movement between the operating position and the kneel position is accomplished by applying a force to release cam 137 to rotate release cam 137 and disengage the pawl 135 from the recliner arm 136. Recliner arm drive posts 156 travel toward slot ends 179, 181 to provide proper timing for transition to the kneel position. The kneel latch 106 is concurrently actuated by rotation of the release cam 172. Rotation of the release cam 172 results in disengagement of the pawl 174. After the pawl 174 is disengaged, the pawl 174 is disengaged from lock feature 176. Once the pawl 174 is disengaged from lock feature 176, the recliner arm 136 may be rotated in a clockwise direction, relative to the view shown in FIG. 10, about the support bracket 132 and the kneel latch 106 may be rotated in a clockwise direction, relative to the view shown in FIG. 10, about the base 115. Such movement of the recliner arm 136 and kneel latch 106 allows transition of the vehicle seat recliner assembly 110 from a seating position to a kneel position.

Movement of vehicle seat recliner assembly 110 into the kneel position causes the first end 163, 165 of the second drive member 157 to urge the carrier member 121 forward and downward along the path of the slots 133, 153. Such movement of the carrier member 121 along slot 133 causes the first drive member 118 to travel forward and downward as well. The first drive member 118 travels along this path until the drive member 118 reaches the end of the slots 133, 153. The recliner arm 136 rotates clockwise, relative to the view shown in FIG. 10, until kneel stop 155 contacts the interior support bracket 152.

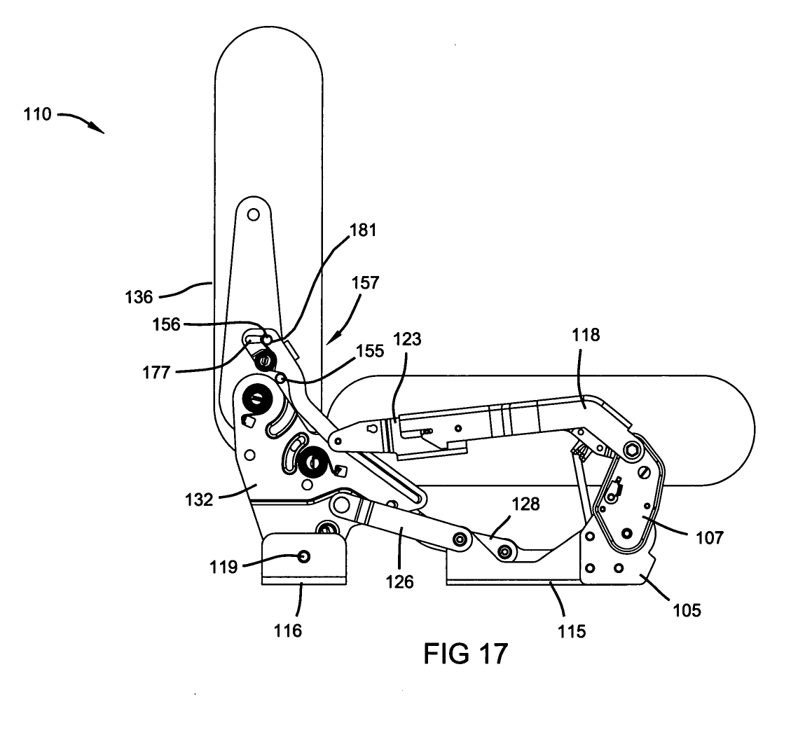

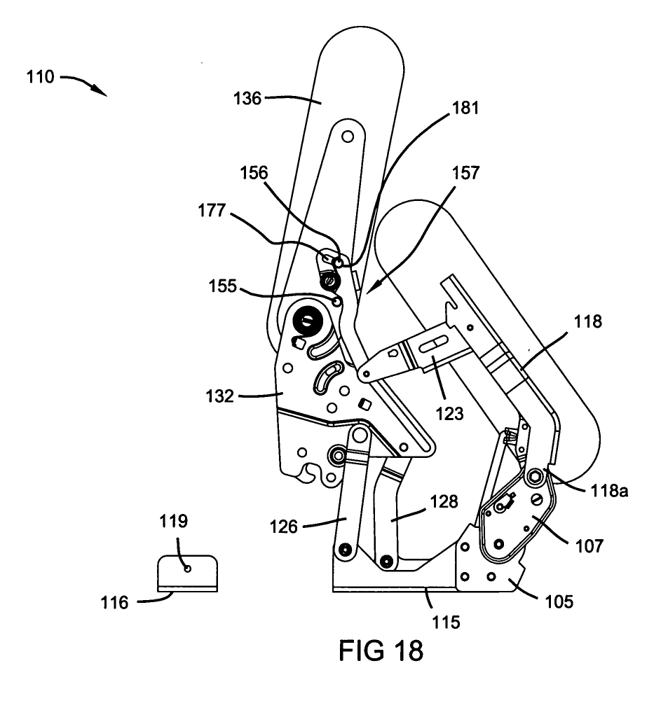

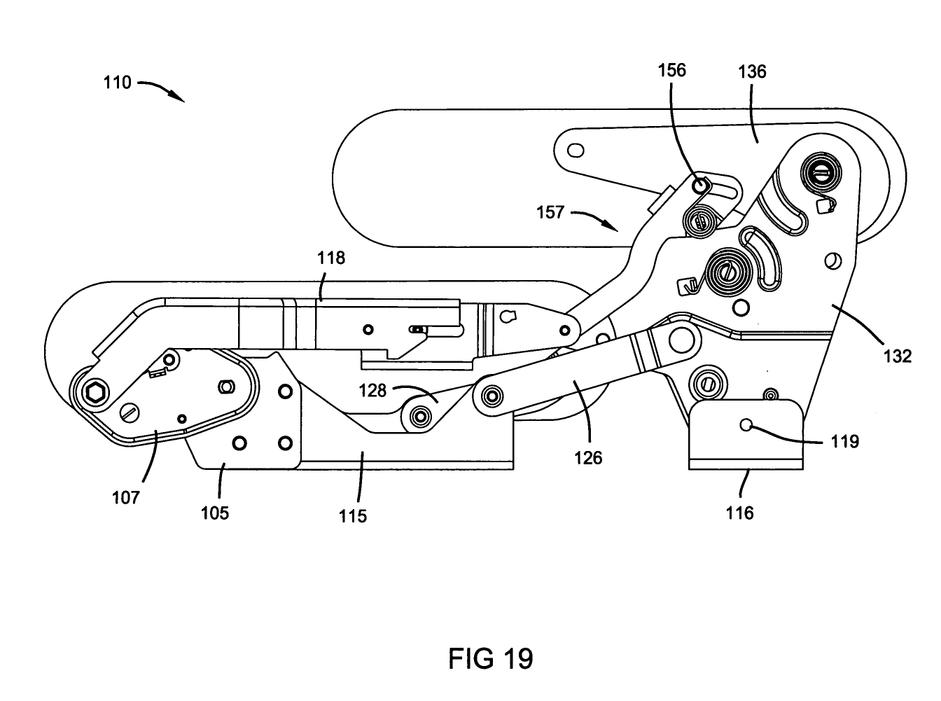

As previously discussed with respect to vehicle seat recliner assembly 10, vehicle seat recliner assembly 110 may be similarly incorporated into a vehicle seat to allow the vehicle seat to be moved between an operating position, an ingress/egress position, and a kneel position as shown in FIGS. 17-19.

The disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A vehicle seat assembly comprising:
a base;
a kneel latch coupled to said base;
a first drive member supported on said kneel latch;
a support bracket located in a common plane with said base, said support bracket having a slot located therein;
a recliner arm pivotally coupled to said support bracket; and
a carrier link having a first end and a second end, said first end of said carrier link pivotally attached to a first end of said first drive member, said second end of said carrier link both pivotally and slidably attached to said slot in said support bracket, said assembly adapted for selective displacement from a seating position to one of an ingress/egress position and a kneel position.

2. The assembly of claim 1, further comprising a second drive member having a first end pivotally attached to said recliner arm and a second end pivotally attached to said carrier link.

3. The assembly of claim 2, wherein said second end of said second drive member is both pivotally and slidably attached to said slot.

4. The assembly of claim 1, wherein a first end of said kneel latch is pivotally coupled to said first drive member and said base.

5. The assembly of claim 4, wherein said kneel latch is adapted to be selectively rotated about said base.

6. The assembly of claim 5, further comprising a kneel latch actuation assembly configured to allow selective rotation of said kneel latch about said base, said kneel latch actuation assembly including a locking member selectively engagable with said base.

7. The assembly of claim 1, wherein said support bracket is disposed both a lateral distance and a vertical distance from said base, said slot extending at an angle generally downward and laterally toward said base.

8. The assembly of claim 1, further comprising a recliner mechanism rotatably attached to said support bracket.

9. The assembly of claim 1, wherein said base is adapted to be attached to a vehicle floor.

10. The assembly of claim 1, further comprising a striker pin latch mechanism configured to selectively couple said support bracket to a vehicle floor.

11. A vehicle seat assembly comprising:
a plurality of lateral subassemblies generally parallel to each other and configured to allow said assembly to be displaced to a plurality of positions including a seating position, an ingress/egress position, and a kneel position, each of said lateral subassemblies including:
a base;
a kneel latch coupled to said base;
a first drive member supported on said kneel latch;
a support bracket located in a common plane with said base, said support bracket having a slot located therein;
a recliner arm pivotally coupled to said support bracket; and
a carrier link having a first end and a second end, said first end of said carrier link pivotally attached to a first end of said first drive member, said second end of said carrier link both pivotally and slidably attached to said slot in said support bracket, said carrier link adapted for selective displacement from a seating position to one of an ingress/egress position and a kneel position.

12. The assembly of claim 11, wherein each of said lateral subassemblies further comprises a second drive member having a first end pivotally attached to said recliner arm and a second end pivotally attached to said carrier link.

13. The assembly of claim 12, wherein said second end of said second drive member is both pivotally and slidably attached to said slot.

14. The assembly of claim 11, wherein a first end of said kneel latch is pivotally coupled to said first drive member and said base.

15. The assembly of claim 14, wherein said kneel latch is adapted to be selectively rotated about said base.

16. The assembly of claim 15, further comprising a kneel latch actuation assembly configured to allow selective rotation of said kneel latch about said base, said kneel latch actuation assembly including a locking member selectively engagable with said base.

17. The assembly of claim 11, wherein said support bracket is disposed both a lateral distance and a vertical distance from said base, said slot extending at an angle generally downward and laterally toward said base.

18. The assembly of claim 11, further comprising a recliner mechanism rotatably attached to said support bracket.

19. The assembly of claim 11, wherein said base is adapted to be attached to a vehicle floor.

20. The assembly of claim 11, further comprising a striker pin latch mechanism configured to selectively couple said support bracket to a vehicle floor.
